(19) United States
(12) Patent Application Publication
(10) Pub. No.: US 2024/0385950 A1
(43) Pub. Date: Nov. 21, 2024

(54) FAULT INJECTION OPTIMIZATION USING APPLICATION CHARACTERISTICS UNDER TEST

(71) Applicant: International Business Machines Corporation, Armonk, NY (US)

(72) Inventors: Mudit Verma, New Delhi (IN); Sandeep Hans, New Delhi (IN); Eitan Daniel Farchi, Haifa (IL); Diptikalyan Saha, Bangalore (IN); Praveen Jayachandran, Bangalore (IN)

(21) Appl. No.: 18/317,164

(22) Filed: May 15, 2023

(51) Int. Cl. G06F 11/36; G06F 11/07

(52) U.S. Cl. CPC G06F 11/3688; G06F 11/0781; G06F 11/3692

(57) ABSTRACT

A method for fault injection optimizations is presented including performing offline application analysis to identify different characteristics of various components of an application, determining faults that are suitable for each component by profiling resource characteristics, analyzing an application topology to identify critical services that are essential to an overall functioning of the application, generating fault-service pairs that have an absolute outcome, assigning priorities to the fault-service pairs, by machine learning, to prioritize which of the faults are injected into the application, and injecting the prioritized faults into the application to induce chaos to the application during controlled testing experiments.

### BACKGROUND

The present invention relates generally to chaos testing, and more specifically, to fault injection optimization using application characteristics under test.

Chaos testing is an approach to test a system's resiliency by actively simulating and identifying failures in a given environment before they cause unplanned downtime or a negative user experience. Engineers and developers use chaos engineering to create a system of monitoring tools and actively run chaos testing in a production environment. This allows engineering teams to see real-life simulations of how their software applications or service responds to different stress levels.

### SUMMARY

In accordance with an embodiment, a computer-implemented method for fault injection optimizations is provided. The computer-implemented method includes performing offline application analysis to identify different characteristics of various components of an application, determining faults that are suitable for each component by profiling resource characteristics, analyzing an application topology to identify critical services that are essential to an overall functioning of the application, generating fault-service pairs that have an absolute outcome, assigning priorities to the fault-service pairs, by machine learning, to prioritize which of the faults are injected into the application, and injecting the prioritized faults into the application to induce chaos to the application during controlled testing experiments.

In accordance with another embodiment, a computer program product for fault injection optimizations is provided. The computer program product includes a computer readable storage medium having program instructions embodied therewith, the program instructions executable by a hardware processor to cause the hardware processor to perform offline application analysis to identify different characteristics of various components of an application, determine faults that are suitable for each component by profiling resource characteristics, analyze an application topology to identify critical services that are essential to an overall functioning of the application, generate fault-service pairs that have an absolute outcome, assign priorities to the fault-service pairs, by machine learning, to prioritize which of the faults are injected into the application, and inject the prioritized faults into the application to induce chaos to the application during controlled testing experiments.

In accordance with yet another embodiment, a system for fault injection optimizations is provided. The system includes a hardware processor and a memory that stores a computer program which, when executed by the hardware processor, causes the hardware processor to perform offline application analysis to identify different characteristics of various components of an application, determine faults that are suitable for each component by profiling resource characteristics, analyze an application topology to identify critical services that are essential to an overall functioning of the application, generate fault-service pairs that have an absolute outcome, assign priorities to the fault-service pairs, by machine learning, to prioritize which of the faults are injected into the application, and inject the prioritized faults into the application to induce chaos to the application during controlled testing experiments.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of an exemplary chaos testing architecture, in accordance with an embodiment of the present invention;

FIG. 2 is a block/flow diagram of an exemplary microservices processing system employing the chaos testing architecture of FIG. 1, in accordance with an embodiment of the present invention;

FIG. 3 is a block/flow diagram of an exemplary practical application involving a Robot-shop application, in accordance with an embodiment of the present invention;

FIG. 4 is a block/flow diagram of an exemplary artificial intelligence (AI) assisted system that automatically recommends, selects, and prioritizes best test cases for components of the application, in accordance with an embodiment of the present invention;

FIG. 5 is a block/flow diagram of an exemplary method for applying the chaos testing architecture of FIG. 1 where fault-service pairs are created, in accordance with an embodiment of the present invention;

FIG. 6 is a block/flow diagram of an exemplary method for applying the chaos testing architecture of FIG. 1 where priorities are assigned to the fault-service pairs, in accordance with an embodiment of the present invention;

FIG. 7 is a block diagram of an exemplary computer system to apply the chaos testing architecture of FIG. 1, in accordance with an embodiment of the present invention;

FIG. 8 is an exemplary table classifying the available faults into categories for the practical application of FIG. 3, in accordance with an embodiment of the present invention;

FIG. 9 is an exemplary weightable fault injection table, in accordance with an embodiment of the present invention; and

FIG. 10 is an exemplary fault-service pair with assignable weightage table, in accordance with an embodiment of the present invention.

Throughout the drawings, same or similar reference numerals represent the same or similar elements.

### DETAILED DESCRIPTION

Embodiments in accordance with the present invention provide methods and devices for fault injection optimizations utilizing application characteristics under test. Before defining chaos testing, it is important to know what chaos engineering is. Chaos engineering allows testers to determine an application's quality by expanding their skills beyond traditional testing methods. Chaos engineering involves using unexpected and random failure conditions to identify system bottlenecks, vulnerabilities, and weaknesses. Chaotic testing is a modern-day DevOps practice that uses unexpected and random conditions, actions, and failures to determine the resilience of a software product or a system. In this process, testers deliberately inject failures and faults into a system's infrastructure to test how the system responds. When done in a controlled manner, this method is effective for preparing, practicing, minimizing, and preventing outages and downtimes before the occurrence. In other words, it is a purposefully induced crash to a production system to intentionally harm the application in production and see how things go.

Chaotic testing is more productive for testers due to its practical nature. Chaotic testing helps testers expand their respective skill sets and add more value to building a higher-quality application. The Quality Assurance (QA) team can start by setting the system's baseline or optimal state. After that, testers consider potential weaknesses and create test scenarios based on those weaknesses and their impact. The next step is test execution with the help of available resources to fix the production server in case a problem appears. For instance, if an issue occurs during a test in the blast radius, the engineering team should divert the necessary resources for reinstating the production server as per requirement.

The key to a successful chaotic testing stint is seamless cooperation and coordination between the DevOps and QA testing teams. The DevOps team has the necessary restoration skills to bring the production server to normalcy. Testers can easily break back-end and hardware connections to determine the impact of the blow on the product. Therefore, while testing in production, it is important to leverage both abilities to facilitate optimal chaos testing, including development, implementation, and support. Another way to make the most out of chaos testing is by executing tests at durations that are not considered peak hours. This helps minimize customer performance effects, thereby maintaining brand reputation.

Chaotic testing differs from standard testing in numerous ways. Chaos tests take into account the various touchpoints that are beyond the scope of testing, whereas normal testing only considers the ones that are within the scope of the testing. Regular testing usually occurs during the project's build/compile phase, whereas chaotic testing occurs once the system is complete. Unlike chaotic testing, regular testing does not usually include the testing of varying configurations, behaviors, outages, and other interruptions caused by a third-party entity. Standard testing only sometimes identifies the easy fix of end-user negative reactions. Standard testing results in a disabled system that needs to be fixed before testing can resume. On the other hand, chaos testing introduces issues into the system to see how it reacts. Regular testing uncovers bugs, and a blocker can cause a system hang. Chaotic testing, on the other hand, has a predetermined abort plan that allows errors if the expected reactions are incorrect.

The exemplary embodiments of the present invention offer an application offline analysis to determine components key characteristics and use such analysis to find suitable faults, without the need for fault injection. An offline study of the application and its components (e.g., microservices) behavior can be performed by analyzing telemetry, and categorizing and classifying application components into different categories such as “Network/CPU/Memory” intensive. A microservice topology can provide the information regarding critical services. Similarly, fault sets can also be categorized into Network, CPU, and Memory related faults. A label and match can be performed and a class of faults can be suggested or recommended, and given more weight against a component of an application.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

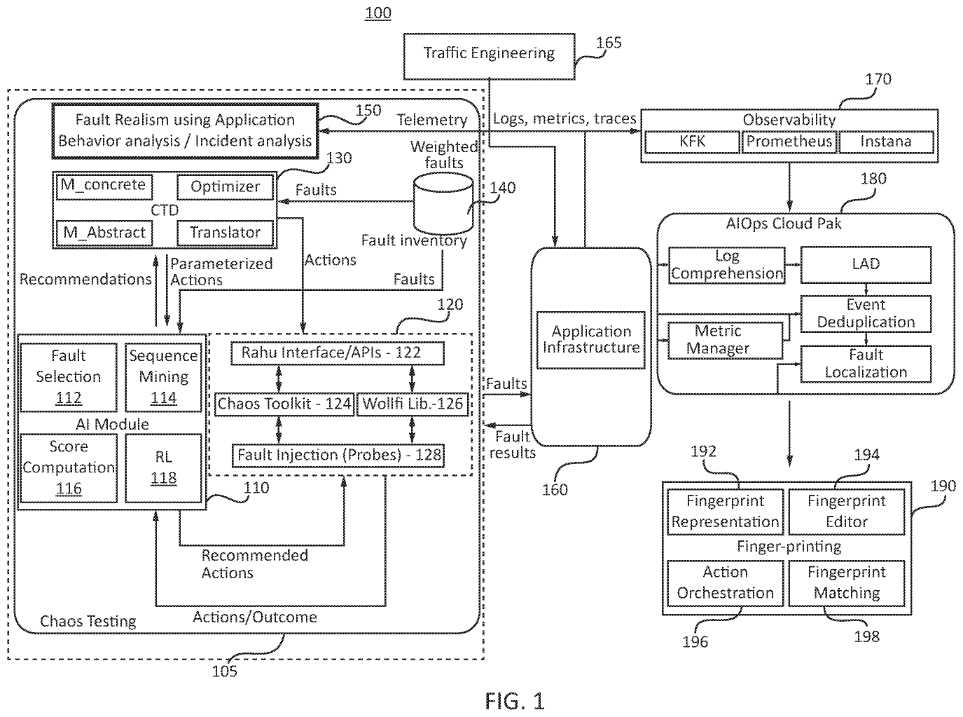

FIG. 1 is a block/flow diagram of an exemplary chaos testing architecture, in accordance with an embodiment of the present invention.

The practice of chaos testing is widely utilized for assessing the resilience of a system in the face of unfavourable conditions by deliberately introducing faults into its various components. However, existing chaos testing tools and methods frequently rely on the arbitrary or subjective selection of individual faults to be injected into different components of a target system. Furthermore, due to the immense size of the overall chaos-test space, it is nearly impossible to cover all scenarios in a cost and time-effective manner, and many faults may not even be relevant or appropriate for the particular system under examination. Specifically, the present chaos engineering tools do not consider the unique characteristics of different components of an application as a determining factor in identifying suitable test cases. An artificial intelligence (AI) assisted system, that can automatically recommend, select and prioritize the best test cases for different components of an application can greatly help Site Reliability Engineering (SRE) in ensuring the overall reliability in a timebound manner.

The behavior of different components of an application is contingent upon the business sub-functions they implement. As such, not all types of faults may be relevant to each component. By subjecting the application to varying workloads, the exemplary methods can characterize the application's resource utilization patterns. Through this process, the exemplary methods can classify the different components (e.g., microservices) into various categories such as compute-intensive, memory-intensive, or network-intensive. This information can be used to determine which types of faults are most likely to occur in a given component and to prioritize testing efforts.

Additionally, the exemplary methods can classify the available faults into the corresponding categories, such as network-related faults, memory-related faults, and CPU-related faults. This information can be used to understand the potential impact of a given fault on the application and to prioritize the injection of faults. By utilizing the assumption that a network-intensive service is more likely to encounter network-related faults and so on, the exemplary methods can make an informed prediction about which faults are more probable to occur in a given component and subsequently inject only those faults. This approach can help to optimize the test coverage and reduce the number of test cases needed.

Furthermore, the exemplary methods can prioritize the likely faults while not completely eliminating the possibility of other faults also occurring in a given component. This approach allows for a more comprehensive testing approach, while still focusing on the most likely faults. Additionally, the exemplary methods can study the interactions between different components and construct a connectivity graph. By utilizing graph algorithms such as degree centrality, the exemplary methods can identify the critical components in an application and prioritize them for testing. This approach can help to identify potential points of failure and to ensure that the most important components of the application are thoroughly tested.

Referring back to FIG. 1, the chaos testing architecture 100 is presented. It is noted that a single application can include several components or microservices. The single application is thus composed of many loosely coupled, and independently deployable smaller components or microservices.

The chaos testing section 105 includes a chaos testing artificial intelligence (AI) machine 110. The chaos testing section 105 enables the generation of a chaos engineering experiment to test one or more faults in a distributed system. The chaos testing AI machine 110 includes a fault selector 112, a sequence miner 114, a score computation component 116, and a reinforcement learning (RL) component 118.

The chaos testing AI machine 110 communicates with a chaos analyzer 120 including APIs or interfaces 122, a chaos toolkit 124, a Wollfi library 126, and a fault injector 128.

The fault injector 128 can also be referred to as a probe that provides the ability to understand the experiment's impact on the system or other dependent systems and measure the steady state of the system during chaos experiments. Probes help provide feedback from the experiment, so that the user doesn't have to monitor or observe impacts on tested systems manually.

The chaos testing AI machine 110 sends recommendations and/or actions to the chaos analyzer 120. In return, the chaos analyzer 120 sends actions and/or outcomes to the chaos testing AI machine 110. The chaos testing AI machine 110 further communicates with a chaos testing deliverer 130 including at least an optimizer and a translator. A fault inventory 140 communicates with the chaos testing deliverer 130 and with a telemetry component 150. The fault inventory 140 receives weighted faults from the telemetry component 150 and the fault inventory component 140 provides faults to the chaos testing deliverer 130, as well as the chaos testing AI machine 110.

The chaos analyzer 120 communicates with the application infrastructure 160. The application infrastructure 160 receives faults from the chaos analyzer 120 and the chaos analyzer 120 transmits fault results to the application infrastructure 160. A traffic engineering component 165 communicates with the application infrastructure 160.

Logs, metrics, and traces from the telemetry component 150 are provided to an observability component 170, which communicates with a AIOps Cloud Pak 180, which in turn, can communicate with a fingerprinting device 190. The fingerprinting device 190 includes a fingerprint representer 192, a fingerprint editor 194, an action orchestrator 196, and a fingerprint matcher 198. Thus, to accurately fingerprint a diverse set of microservices based on their system call activities, the machine learning approach of the chaos testing section 105 is utilized.

The chaos testing section 105 enables teams to define, measure, tune, and customize each experiment to track resiliency over time and automate experiment results. Each experiment can have different weights assigned to signify low, medium, and high priority tests. Leveraging a defined score with a consistently-executed experiment provides trends on health metrics on how system behavior changes during failure events. Signals can be sent to users (e.g., user interface of a computing device) based on changes to predetermined scores. The chaos testing section 105 further enables a user to start, stop, and re-run experiments within one or more user interfaces, thus allowing a team to test in small increments of failure. The team can also take notes and observations, and create a checklist of tasks they need to complete, which can be added to a ticketing system.

The chaos testing AI machine 110 is a specialized machine that only handles chaos testing data and/or information, and only outputs chaos testing variables and/or parameters. The chaos testing AI machine 110 can create hypothesis, can identify fault variables, can initiate an experiment, and can measure the impact of applying one or more faults. The chaos testing AI machine 110 is thus a specialized machine designed to predict potential high-impact faults, and can run on specialized chaos testing hardware realized by specialized chaos testing circuitry. The chaos testing AI machine 110 improves the technical functioning of the computer by reciting a specific technique for improving fault selection techniques by incorporating a fault selector 112, a sequence miner 114, a score computation component 116, and a reinforcement learning (RL) component 118. The chaos testing AI machine 110 is a specialized machine that is configured or programmed to categorize and classify components (e.g., microservices) into network, CPU, and memory categories, as well as categorize and classify faults into network, CPU, and memory categories. This clearly results in an improvement in computer functionality that is not a mental process since performance data based on selected faults is received in response to actions processed by the chaos testing AI machine 110.

Therefore, chaos engineering corresponds to the practice of experimenting of a distributed system in production in order to build confidence in the system's capability to withstand turbulent conditions. In particular, chaos engineering involves the creation of a hypothesis around a steady-state mode of the distributed system in order to define acceptable thresholds for a normal operating state as well as when the distributed system is experiencing turbulence. Hypotheses are tested via experiments, e.g., chaos engineering experiments, in order to determine if the distributed system behaves as expected, that is, validates the hypothesis, or not, that is, violates/invalidates the hypothesis. These hypotheses are applied to the distributed system via failure injections. The distributed system's response to the failure injections is observed and then used to determine the hypothesis' validity. If the hypothesis is validated, then confidence in the distributed system's resiliency can be increased. Otherwise, if the hypothesis is violated, the distributed system will need to be upgraded based on the scenarios defined in the hypothesis. Accordingly, even if the chaos experiments fail, they can help discover and mitigate failure modes in the distributed system, which, when addressed, can lead to increased resiliency. In view thereof, a fault selection process is desired which can help users determine which components of an application should be chaos tested, which specific faults should be injected into the components of the application, and to provide a prioritization scheme to avoid random, intuition-based chaos testing.

As a result, the exemplary chaos testing architecture 100 allows a user to determine which components of the application to expose to chaos testing, which faults to inject into which components (e.g., microservices), how to prioritize the faults, and determine which faults lead to disruption. The issue with existing chaos testing techniques is that they are random, intuition-based, time-consuming, cumbersome, and devoid of realism, thus leading to sub-optimal coverage and inadequate resiliency testing. In contrast, the exemplary chaos testing architecture 100 provides for an offline study of the application and its components behavior, which can be performed by analyzing telemetry, and categorizing and classifying application components into different categories such as “Network/CPU/Memory” intensive. A microservice topology can provide the information regarding critical services. Similarly, fault sets can also be categorized into Network, CPU, and Memory related faults. A label and match can be performed, and a class of faults can be suggested or recommended, and given more weight against a component of an application.

Stated differently, a system is presented to perform automated application analysis of its different components (e.g., microservices) to find suitable faults for different components in an application without any real fault injection by utilizing methods to perform offline application analysis to find different characteristics of different components (microservices) in an application, e.g., network, memory, and compute intensity, critical services using the application topology, and fault-service pairs with absolute “Inject-No Inject” outcomes, as well as fault-service pairs with assigned priorities to be used for fault prioritization.

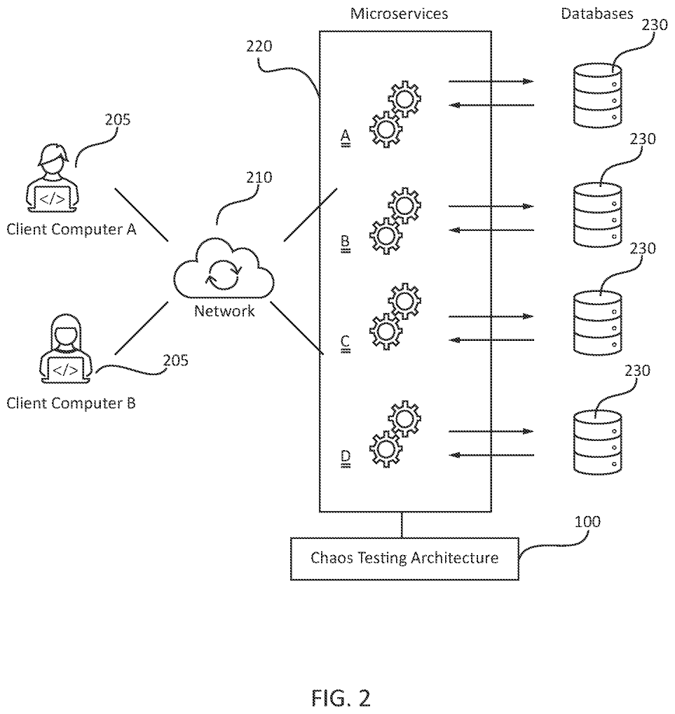

FIG. 2 is a block/flow diagram of an exemplary microservices processing system employing the chaos testing architecture of FIG. 1, in accordance with an embodiment of the present invention.

In the microservices processing system employing the chaos testing architecture of FIG. 1, client computers 205 can access microservices 220 via network 210. In one instance, there are four microservices 220, that is, microservice A, microservice B, microservice C, and microservice D. Each microservice 220 is associated with a database 230. The microservices 220 can be run on the chaos testing architecture 100. It is noted that a single application can include several components or microservices. The single application is thus composed of many loosely coupled, and independently deployable smaller components or microservices. These services usually have their own technology stack, inclusive of the database and data management model. These microservices communicate with one another over a combination of, e.g., API's, event streaming, and message brokers.

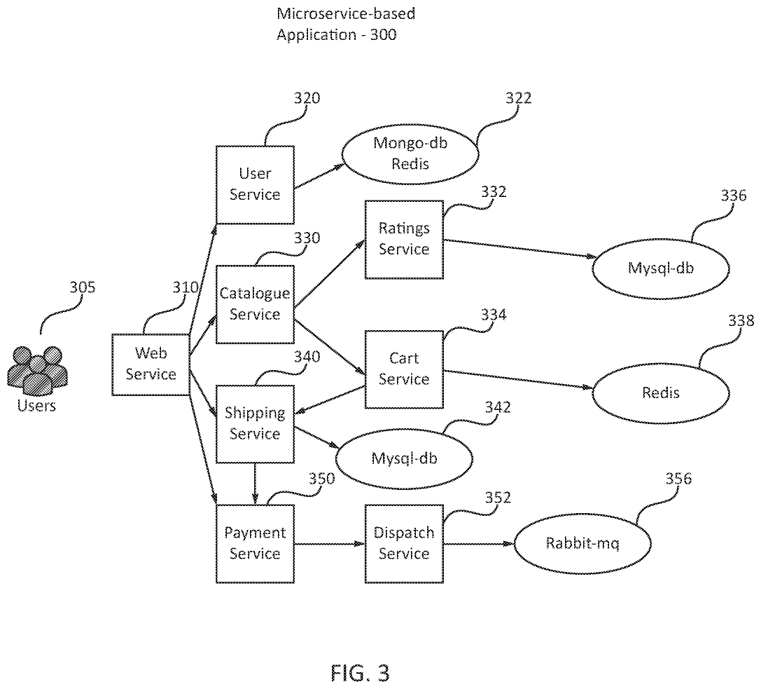

FIG. 3 is a block/flow diagram of an exemplary practical application involving a Robot-shop application 300, in accordance with an embodiment of the present invention.

In the Robot-shop application 300, users 305 are using a web service 310. The Robot-shop application 300 includes 12 microservices. The web service 310 can access a user service 320, a catalogue service 330, a shipping service 340, and a payment service 350. The user service 320 includes Mongo-db Redis 322. The catalogue service 330 includes a ratings service 332 and a cart service 334. The shipping service 340 includes Mysql-db 342. The payment service 350 includes a dispatch service 352. The dispatch service 325 includes Rabbit-mq 356. Moreover, the rating service 332 includes Mysql-db 336 and the cart service 334 includes Redis 338.

MongoDB is a source-available cross-platform document-oriented database program. Classified as a not only SQL (NoSQL) database program, MongoDB uses JSON-like documents with optional schemas.

Redis is an in-memory data structure store, used as a distributed, in-memory key-value database, cache and message broker, with optional durability. Redis supports different kinds of abstract data structures, such as strings, lists, maps, sets, sorted sets, HyperLogLogs, bitmaps, streams, and spatial indices.

MySQL is an open-source relational database management system. A relational database organizes data into one or more data tables in which data may be related to each other. These relations help structure the data. Structured Query Language (SQL) is a language programmers use to create, modify and extract data from the relational database, as well as control user access to the database. In addition to relational databases and SQL, an RDBMS like MySQL works with an operating system to implement a relational database in a computer's storage system, manages users, allows for network access and facilitates testing database integrity and creation of backups.

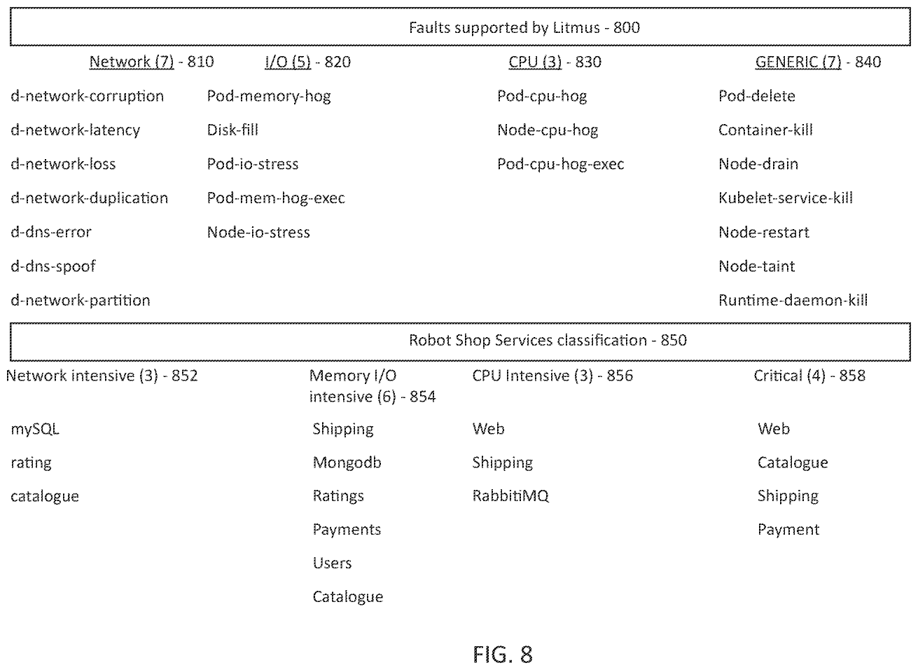

The Robot-shop application 300 is a sample microservices application that can be used as a sandbox to test and learn containerized application orchestration and monitoring techniques. The Robot-shop application 300 was employed as a practical application. In particular, a load was generated by using a default load-gen stress test. Telemetry associated with resource consumption was monitored during experimentation. Specifically, CPU, memory, and network consumption was monitored for each microservice in the Robot-shop application 300. It was determined that web services 310 and shipping services 340 were compute-intensive as opposed to user services 320 and payment services 350. It was also determined that MySQL 342 and ratings services 332 were network-intensive services as opposed to Rabbit-mq 356 and cart services 334. This is further illustrated in tables 800 and 850 of FIG. 8 below.

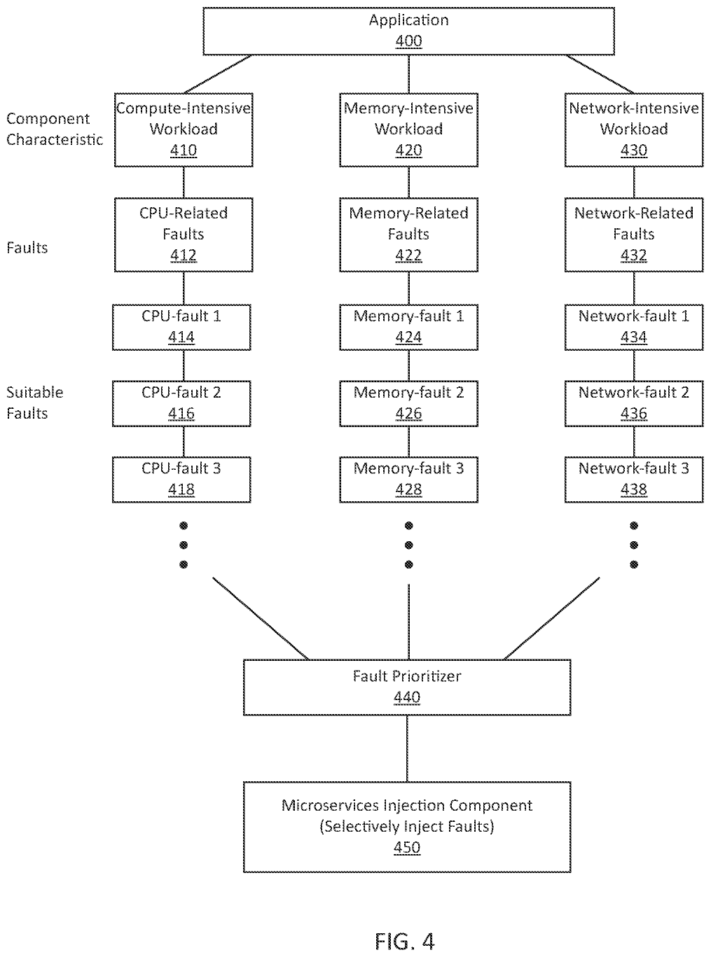

FIG. 4 is a block/flow diagram of an exemplary artificial intelligence (AI) assisted system that automatically recommends, selects, and prioritizes best test cases for components of a application, in accordance with an embodiment of the present invention.

The application 400 includes several different components. These components are subjected to varying workloads. The workloads include a compute-intensive workload 410, a memory-intensive workload 420, and a network-intensive workload 430. By subjecting the components of the application 400 to various workloads, the exemplary methods can characterize the application's resource utilization patterns. Thus, the exemplary embodiments can classify the different components into various fault categories. The fault categories can include CPU-related faults 412, memory-related faults 422, and network-related faults 432.

The CPU-related faults 412 can include a first CPU fault 414, a second CPU fault 416, and a third CPU fault 418. The memory-related faults 422 can include a first memory fault 424, a second memory fault 426, and a third memory fault 428. The network-related faults 432 can include a first network fault 434, a second network fault 436, and a third network fault 438. Thus, the available faults are classified in the corresponding categories and each category includes suitable faults. This information can be used to understand the potential impact of a given fault on the application 400 and to prioritize the injection of faults. A fault prioritizer 440 can be used to prioritize all the faults. By utilizing the assumption that a network intensive service is more likely to encounter network-related faults and so on, the exemplary methods can make an informed prediction about which faults are more probable to occur in the given component and subsequently inject only those faults.

After the fault prioritizer 440 prioritizes the faults, a microservices injection component 450 selectively injects the selected faults. In one example, the application 400 is subjected to all three workloads 410, 420, 430. In such example, it is determined that the memory-intensive workload 420 utilizes the most resources. As such, the memory-related faults 422 are prioritized. In particular, it is further determined that the second memory fault 426 and the third memory fault 428 have more of a potential impact. As a result, the second memory fault 426 and the third memory fault 428 are prioritized by the fault prioritizer 440 and the second memory fault 426 and the third memory fault 428 are selectively injected as faults by the microservices injection component 450. Therefore, the faults are not randomly selected. Instead, by determining which workload is more intensive, the exemplary methods of the present invention focus on the faults associated with such workload. Then, those predetermined faults within that workload are analyzed to determine which ones have the biggest potential impact. The fault prioritizer 440 then select such faults with the biggest or highest potential impact to be injected as faults into the chaos testing architecture 100 to fault test the application 400. This approach can help optimize the test coverage and reduce the number of test cases needed. Stated differently, this information can be used to determine which types of faults are most likely to occur by any given component of the prioritized testing efforts. The exemplary methods can thus prioritize the likely faults while not completely eliminating the possibility of other faults also occurring in a given component. This approach allows for a more comprehensive testing mechanism, while still focusing on the most likely faults. As a result, this is not a random mechanism in selecting faults as with conventional systems. Instead, this is a deliberate or well-thought out or planned approach in determining or choosing which faults to select based on resource utilization patterns (intensity workloads).

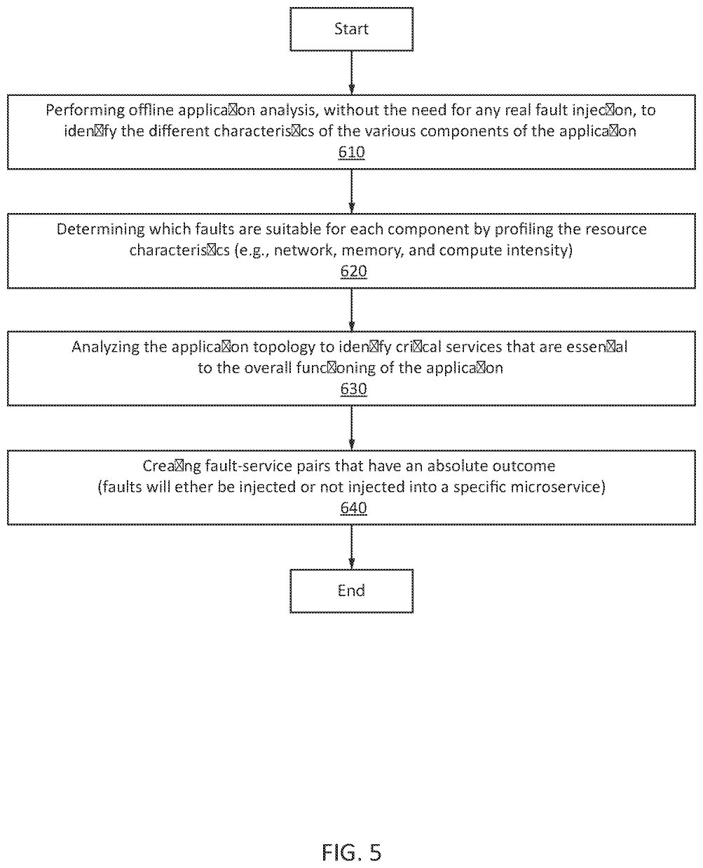

FIG. 5 is a block/flow diagram of an exemplary method for applying the chaos testing architecture of FIG. 1 where fault-service pairs are created, in accordance with an embodiment of the present invention;

At block 610, perform offline application analysis, without the need for any real fault injection, to identify the different characteristics of the various components of the application.

At block 620, determine which faults are suitable for each component by profiling the resource characteristics (e.g., network, memory, and compute intensity).

At block 630, analyze the application topology to identify critical services that are essential to the overall functioning of the application.

At block 640, create fault-service pairs that have an absolute outcome (faults will either be injected or not injected into a specific microservice).

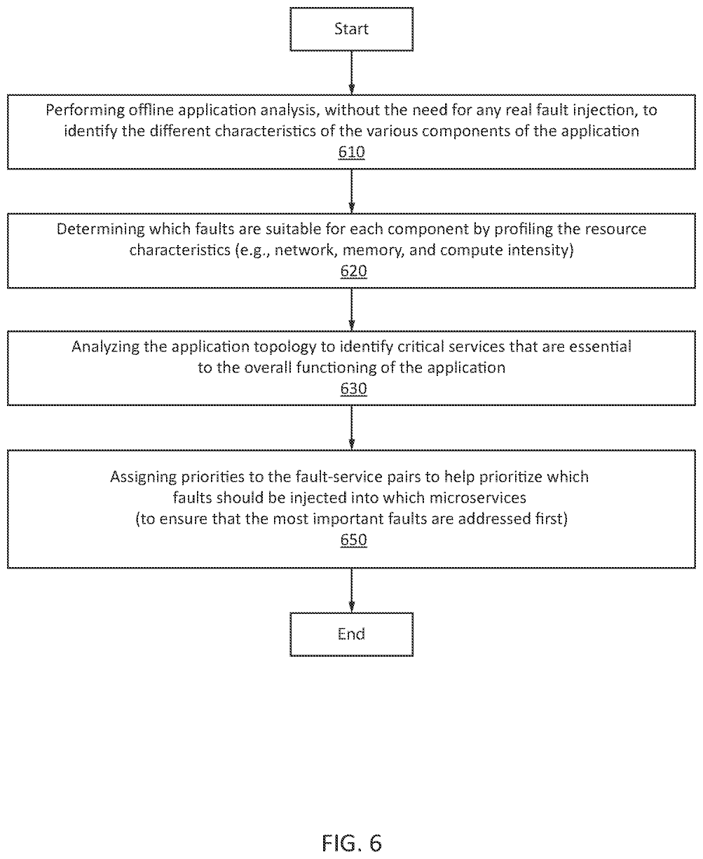

FIG. 6 is a block/flow diagram of an exemplary method for applying the chaos testing architecture of FIG. 1 where priorities are assigned to the fault-service pairs, in accordance with an embodiment of the present invention.

At block 610, perform offline application analysis, without the need for any real fault injection, to identify the different characteristics of the various components of the application.

At block 620, determine which faults are suitable for each component by profiling the resource characteristics (e.g., network, memory, and compute intensity).

At block 630, analyze the application topology to identify critical services that are essential to the overall functioning of the application.

At block 650, assign priorities to the fault-service pairs to help prioritize which faults should be injected into which microservices (to ensure that the most important faults are addressed first). Thus, the prioritized faults are injected into the application to induce chaos to the application during controlled testing experiments.

The chaos testing architecture 100 can be applied to or used in several practical applications. For example, in one practical application, load balancers distribute incoming network traffic across a group of backend servers. Load balancers route requests to ensure they're handled with maximum speed and efficiency. If a server goes down, the load balancer adjusts by routing and distributing traffic to the other servers. With chaos engineering, load balancer settings can be tested to see if they're optimal for reducing outages. An experiment can be run where a target is deregistered from the load balancer's target group. An observation can then take place to see what happens. Will traffic still be routed and distributed efficiently, or will it crash the system? The chaos testing architecture 100 aids in subjecting the components of the load balancer application to various workloads to characterize the load balancer application's resource utilization patterns. Thus, the exemplary embodiments can classify the different components into various fault categories. The available faults are classified in the corresponding categories (e.g., network, memory, CPU) and each category includes suitable faults. This information can be used to understand the potential impact of a given fault on the load balancer application and to prioritize the injection of faults into the load balancer system.

Another practical application can relate to CPU spikes. Sometimes a local machine is going to run slowly. Prolonged speed issues generally indicate a CPU spike issue, that is, a CPU hog. A process is stuck somewhere and it's keeping other programs from running properly. A chaos engineering experiment can be run to force a CPU spike to see how well different apps on the local machine function under the stress. The spike percentages can even be customized to reflect varying degrees of spikiness. It's a great way to test the system's resiliency and find the thresholds for handling volume. The breaking point between acceptable performance can be determined. Once again, the chaos testing architecture 100 aids in subjecting the components of the CPU spike application to various workloads to characterize the application's resource utilization patterns. Thus, the exemplary embodiments can classify the different components into various fault categories. The available faults are classified in the corresponding categories (e.g., network, memory, CPU) and each category includes suitable faults. This information can be used to understand the potential impact of a given fault on the CPU spike application and to prioritize the injection of faults into the CPU spike application.

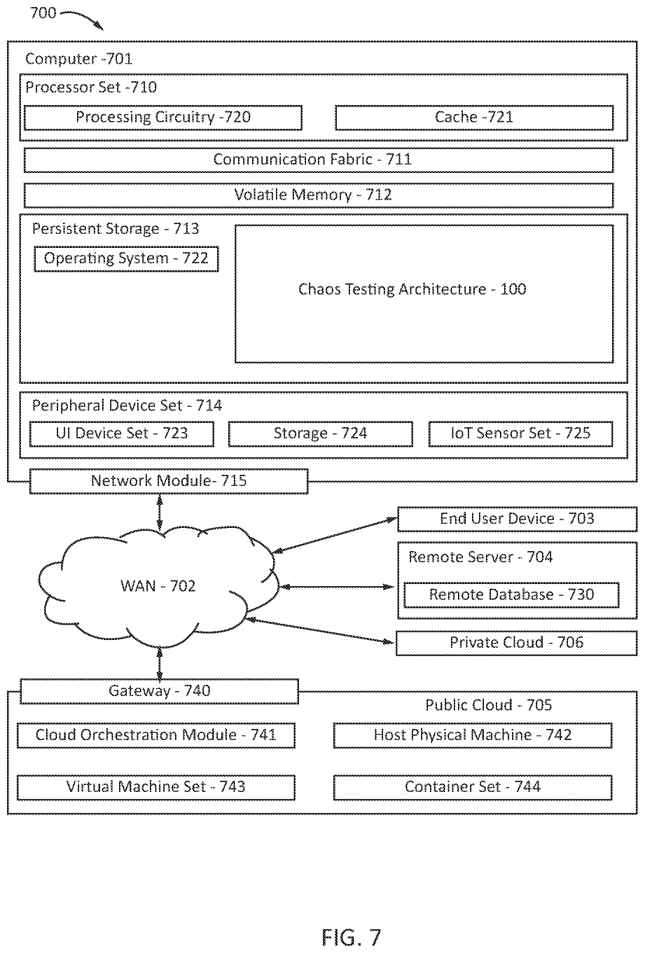

FIG. 7 is a block diagram of an exemplary computer system to apply the chaos testing architecture of FIG. 1, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the chaos testing architecture 100. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

FIG. 8 is an exemplary table classifying the available faults into categories for the practical application of FIG. 3, in accordance with an embodiment of the present invention.

The table 800 illustrates the faults. For example, there is a list of network faults 810, memory faults 820, CPU faults 830, and generic faults 840. Thus, the faults are classified and categorized.

The table 850 illustrates the Robot Shop Services classification, including a list of network-intensive workloads 852, memory-intensive workloads 854, CPU-intensive workloads 856, and critical workloads 858. Therefore, as in FIG. 4, the fault prioritizer 440 can be used to prioritize all the faults listed in the network faults 810, the memory faults 820, the CPU faults 830, and the generic faults 840. By utilizing the assumption that a network intensive service is more likely to encounter network-related faults and so on, the exemplary methods can make an informed prediction about which faults are more probable to occur in the given component and subsequently inject only those faults.

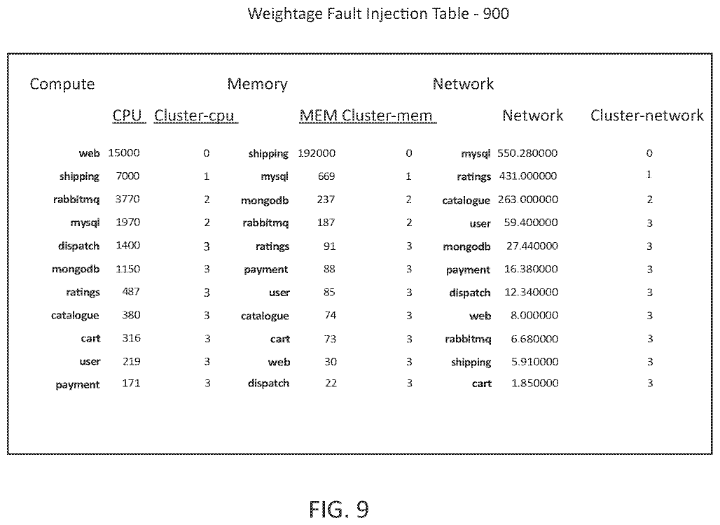

FIG. 9 is an exemplary weightable fault injection table 900, in accordance with an embodiment of the present invention.

The weightable fault injection table includes a list of CPU faults, a list of memory faults, and a list of network faults. As mentioned above, by subjecting the application to varying workloads, the exemplary methods can characterize the application's resource utilization patterns. Through this process, the exemplary methods can classify the different components into various categories such as compute-intensive, memory-intensive, or network-intensive. This information can be used to determine which types of faults are most likely to occur in a given component and to prioritize testing efforts.

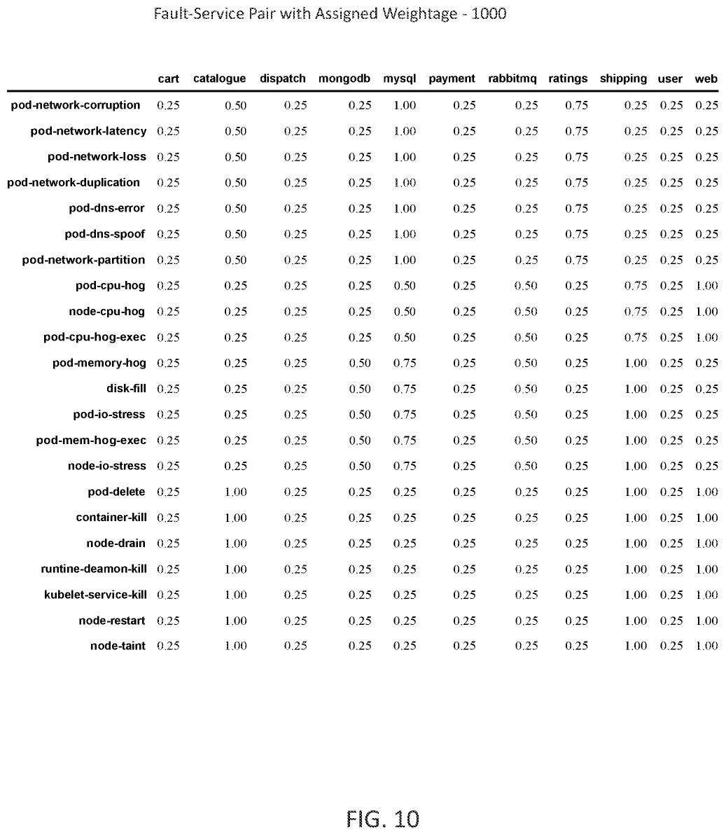

FIG. 10 is an exemplary fault-service pair with assignable weightage table 1000, in accordance with an embodiment of the present invention.

The fault-service pair with assignable weightage table depicts each fault-service pair with an assigned weight, such as, 0.25, 0.50, 0.75, and 1.

In conclusion, the exemplary system aims to automate the process of identifying suitable faults for different components (e.g., microservices) in an application. This is achieved by performing offline application analysis, without the need for any real fault injection, to identify the different characteristics of the various components of the application. These characteristics can be resource profiles (but not limited to), such as network, memory, and compute intensity. This helps determine which faults are suitable for each component. The system analyzes the application topology to identify critical services that are essential to the overall functioning of the application. The system creates fault-service pairs that have an absolute “Inject-No Inject” outcome, meaning that faults will either be injected or not injected into a specific microservice. The system then assigns priorities to the fault-service pairs to prioritize which faults should be injected into which services. This ensures that the most critical faults are addressed first.

Therefore, the exemplary embodiments reduce the overall fault space by identifying potential faults an application is likely to observe and use chaos engineering to inject that. The exemplary methods rely on resource utilization of different components to make an assessment on what categories of faults are more important for a given component. This, compounded with topology of the application, and by using machine learning to assign weightage, provides different priority scores for each fault, service pair or inject-no inject scenarios.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for fault injection optimizations utilizing application characteristics under test (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for fault injection optimizations, the method comprising:
performing offline application analysis to identify different characteristics of various components of an application;
determining faults that are suitable for each component by profiling resource characteristics;
analyzing an application topology to identify critical services that are essential to an overall functioning of the application;
generating fault-service pairs that have an absolute outcome;
assigning priorities to the fault-service pairs, by machine learning, to prioritize which of the faults are injected into the application; and
injecting the prioritized faults into the application to induce chaos to the application during controlled testing experiments.

2. The computer-implemented method of claim 1, wherein the resource characteristics include intensity of network-related workloads, memory-related workloads, and CPU-related workloads.

3. The computer-implemented method of claim 1, wherein the faults are categorized into network-related faults, memory-related faults, and CPU-related faults.

4. The computer-implemented method of claim 1, wherein the absolute outcome is faults injected or not injected into the application.

5. The computer-implemented method of claim 1, wherein the assigning of the priorities involves providing a priority score for each fault-service pair.

6. The computer-implemented method of claim 1, wherein the machine learning includes a chaos testing artificial intelligence (AI) machine having a score computation component, a reinforcement learning (RL) component, a fault selector, and a sequence miner to collectively predict which of the faults are injected into the application.

7. The computer-implemented method of claim 6, wherein the chaos testing AI machine interacts with at least a chaos toolkit and a fault injector to generate the fault-service pairs.

8. A computer program product for fault injection optimizations, the computer program product comprising a computer readable storage medium having program instructions embodied therewith, the program instructions executable by a hardware processor to cause the hardware processor to:
perform offline application analysis to identify different characteristics of various components of an application;
determine faults that are suitable for each component by profiling resource characteristics;
analyze an application topology to identify critical services that are essential to an overall functioning of the application;
generate fault-service pairs that have an absolute outcome;
assign priorities to the fault-service pairs, by machine learning, to prioritize which of the faults are injected into the application; and
inject the prioritized faults into the application to induce chaos to the application during controlled testing experiments.

9. The computer program product of claim 8, wherein the resource characteristics include intensity of network-related workloads, memory-related workloads, and CPU-related workloads.

10. The computer program product of claim 8, wherein the faults are categorized into network-related faults, memory-related faults, and CPU-related faults.

11. The computer program product of claim 8, wherein the absolute outcome is faults injected or not injected into the application.

12. The computer program product of claim 8, wherein the assigning of the priorities involves providing a priority score for each fault-service pair.

13. The computer program product of claim 8, wherein the machine learning includes a chaos testing artificial intelligence (AI) machine having a score computation component, a reinforcement learning (RL) component, a fault selector, and a sequence miner to collectively predict which of the faults are injected into the application.

14. The computer program product of claim 13, wherein the chaos testing AI machine interacts with at least a chaos toolkit and a fault injector to generate the fault-service pairs.

15. A system for fault injection optimizations comprises:
a hardware processor; and
a memory that stores a computer program which, when executed by the hardware processor, causes the hardware processor to:
perform offline application analysis to identify different characteristics of various components of an application;
determine faults that are suitable for each component by profiling resource characteristics;
analyze an application topology to identify critical services that are essential to an overall functioning of the application;
generate fault-service pairs that have an absolute outcome;
assign priorities to the fault-service pairs, by machine learning, to prioritize which of the faults are injected into the application; and
inject the prioritized faults into the application to induce chaos to the application during controlled testing experiments.

16. The system of claim 15, wherein the resource characteristics include intensity of network-related workloads, memory-related workloads, and CPU-related workloads.

17. The system of claim 15, wherein the faults are categorized into network-related faults, memory-related faults, and CPU-related faults.

18. The system of claim 15, wherein the absolute outcome is faults injected or not injected into the application.

19. The system of claim 15, wherein the assigning of the priorities involves providing a priority score for each fault-service pair.

20. The system of claim 15, wherein the machine learning includes a chaos testing artificial intelligence (AI) machine having a score computation component, a reinforcement learning (RL) component, a fault selector, and a sequence miner to collectively predict which of the faults are injected into the application.
